(19) United States
(12) Patent Application Publication
(10) Pub. No.: US 2007/0247571 A1
(43) Pub. Date: Oct. 25, 2007

(54) Metal cutting and welding guide

(76) Inventor: Marlin D. Smith, Socorro, NM (US)

Correspondence Address: DENNIS F ARMIJO, 6300 MONTANO RD. NW, SUITE D, ALBUQUERQUE, NM, 87120, US

(21) Appl. No.: 11/400,088

(22) Filed: Apr. 7, 2006

(51) Int. Cl. G02F 1/1335

(52) U.S. Cl. 349/114

(57) ABSTRACT

A metal cutting and welding guide that aids operator precision in hot metalworking. The guide assists in cutting or welding straighter more precise lines on metal. The guide comprises an arm cradle with a rolling mechanism and arm straps or some similar attaching mechanism. The preferred rolling mechanism moves in a strictly linear motion along the metal. In an alternative embodiment the rolling mechanism can swivel for nonlinear cuts or welds. The invention is affixed to the operator's arm with straps. The rolling mechanism guides the operator as he cuts or welds the metal on a horizontal surface. The operator holds the torch in the arm with the guide attached.

### BACKGROUND OF THE INVENTION

1 Field of the Invention Technical Field

This invention relates to cutting and welding material such as metal, and more specifically to an apparatus and method for providing assistance in cutting and welding materials such as metal to improve precision.

2 Background Art

Typically, cutting and welding metal is performed free hand making it difficult to cut a straight precise line. Devices that are used in hot metalworking either attach to the equipment or are bulky devices that attach to the operator working the hot metal. These devices are restrictive and complicated in nature, some using expansible lazy tongs and rod-like supports. The device in U.S. Pat. No. 2,403,654 to Gerdes illustrates this. In addition, other arm or wrist devices are not applicable for hot metalwork. They are used in other industries such as a device for a computer operator or a writer. For example, see U.S. Pat. No. 5,335,888 to Thomsen; U.S. Pat. No. 5,472,161 to Krukovsky; and U.S. Pat. No. 926,427 to Lacy. These types of devices support the wrist and arm during typing or writing applications, mostly to prevent carpel tunnel syndrome, and not to precisely guide a human hand for cutting or welding. Further, they are not applicable to hot metalwork.

The present invention solves the problem with a simple and comfortable apparatus and method that is inexpensive and simple to use. A user can simply put on the metal cutting and welding guide and begin cutting straighter, cleaner, more precise lines during all metal cutting operations and all welding operations. In addition, the device allows operators to work without the potential hazard of burning themselves as they are cutting because of direct exposure to the hot metal. The device supports the wrist so the operator will not become fatigued. None of the prior art devices provide the unique solution to the aforementioned problem.

### SUMMARY OF THE INVENTION DISCLOSURE OF THE INVENTION

A metal cutting and welding guide allowing an operator to cut or weld metal in straight precise lines is disclosed. The most significant novelty of this particular device in its preferred embodiment is its ability to improve operator's cuts and welds in hot metalworking as well as keep the operator safe from hot metal burns.

The preferred metal cutting and welding guide comprises a u-shaped solid member or cradle piece that fits to, and supports the forearm. The forearm is removeably affixed to the cradle with straps. The preferred embodiment of the cradle has four slots used to connect two straps that will wrap around the forearm. The cradle is attached along its outer circumference to end supports, one at each end of the cradle. Each end support has a rolling mechanism attached. The rolling mechanism is directly below the curved piece. The rolling mechanism guides the operator while he is working the metal. The rolling mechanism can move in a strictly linear direction for straight line cuts or welds or it can swivel. Because the device is so simple and comfortable, it can be worn at all times making it convenient for the operator who may have to routinely cut metal throughout the day. In the preferred embodiment, the invention connects to the operator's arm using well known methods in the art such as Velcro® straps, and guides the operator to cut or weld precise lines while he is working.

A primary object of the present invention is to provide a method and apparatus for producing clean precise cuts and welds.

Another object of the present invention is to reduce the risk of an operator burning their arm during the cutting process.

Yet another object of the present invention is to provide a device that reduces operator arm fatigue in torch cutting and welding operations.

A primary advantage of the present invention is that it provides a safe, easy-to-use device for all types of hot metalwork that will improve the quality of the work being produced.

Another advantage is the lack of interference created between the device and the equipment or the project metal of the present operation.

Yet other advantages of the present invention include simplicity.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a perspective view of the preferred metal cutting and welding guide.

FIG. 2 is a top view of the embodiment of FIG. 1.

FIG. 3 is a view of the embodiment of FIG. 1 in a typical metal cutting operation.

FIG. 4 is a view of the embodiment of FIG. 1 in a typical welding operation.

FIG. 5 is a view of an alternative embodiment with swivel wheels.

### DESCRIPTION OF THE PREFERRED EMBODIMENTS

### BEST MODES FOR CARRYING OUT THE INVENTION

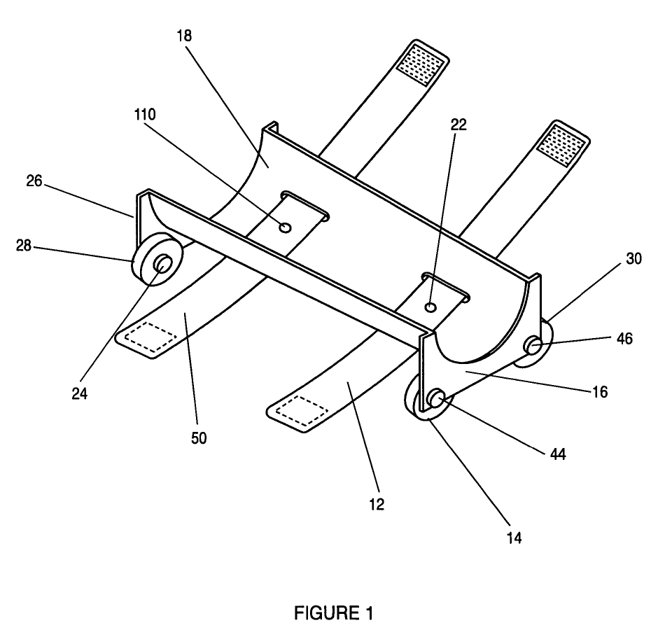

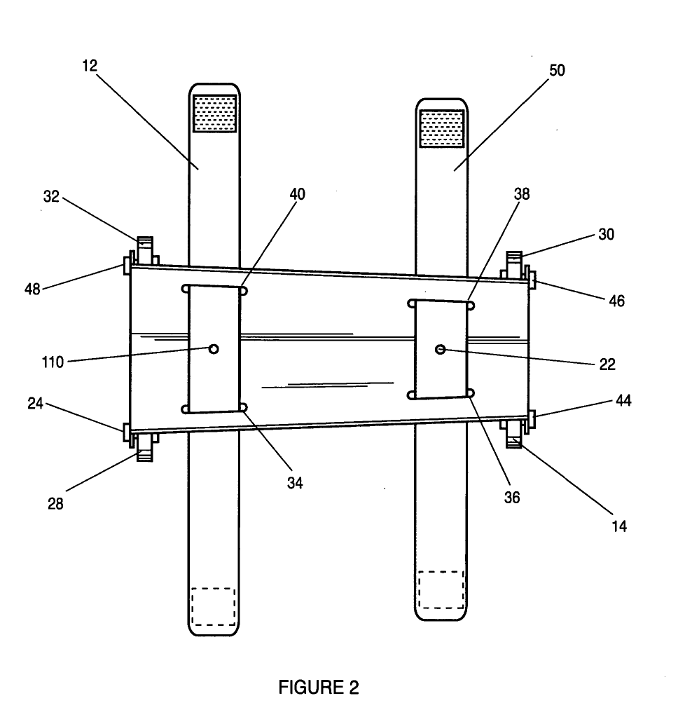

FIG. 1 shows the preferred embodiment of the metal cutting and welding guide invention. Cradle 18 is a solid u-shaped member that fits to an operator's arm. Cradle 18 comes in variable sizes depending on the size of the operator's arm. Cradle 18 can be constructed out of metals, plastics or any suitable material. At each end of cradle 18 are end supports 16 and 26. End supports 16 and 26 connect cradle 18 to a rolling mechanism that guides the operator's movement. In the preferred embodiment, the rolling mechanism is wheels 14, 28, 30, 32 that attach to the bottom of end supports 16 and 26. There are two wheels for each end support. Wheels 14, 28, 30, 32 move linearly, and optionally, can move in a horizontal, vertical or diagonal direction. Wheels 14, 28, 30, 32 attach to end supports 16 and 26 using axles, 24, 44, 46 and 48. Although a wheel embodiment is described, any other linear sliding or rolling mechanism can be used. There is one axle for every wheel. Additionally, as shown in FIG. 2, cradle 18 has four open slots, 34, 36, 38 and 40. Two straps 12 and 50 are inserted from beneath cradle 18 into slots 38 and 40. Straps 12 and 50 are pulled through corresponding slots 34 and 36 and are held to cradle 18 using strap rivets 110 and 22. Strap rivets 110 and 22 attach to the bottom of cradle's 18 u-shaped member. Straps 12 and 50 wrap around the operator's arm to hold the metal cutting and welding guide in place. Straps 12 and 50 can attach to operator's arm using a hook and loop fastening system, belt buckles or any other well known method. Instead of using straps, the cradle can be molded in a way to encase the arm, thus avoiding the need for straps.

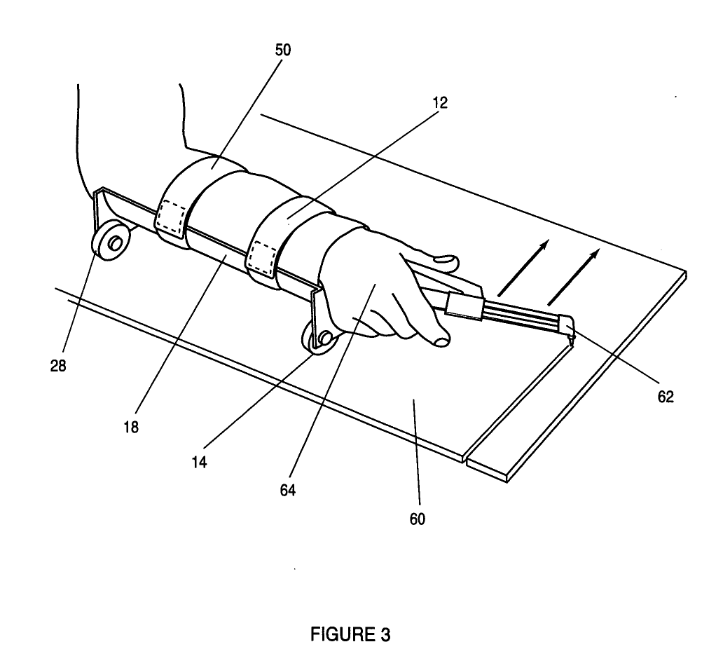

The metal cutting function of the metal cutting and welding guide is shown in FIG. 3. Cradle 18 is wrapped around an operator's arm and fastened using two hook and loop fasteners such as Velcro® straps 12 and 50. The operator places four wheels 14, 28, 30 and 32 onto a horizontal piece of metal 60. The operator holds metal cutting instrument 62 with metal cutting and welding guide in hand 64. Operator then moves his arm in a linear direction across metal piece 60 cutting the metal in a straight line as he goes. The linear wheels keep an operator from drifting from the straight line cut. Due to the strictly linear movement of the wheels in a single axis, the cuts are uniform and straight, obviating drift and other human errors that occur with free hand cutting. Many different types of cutting apparatuses can be used with the preferred metal cutting and welding guide, such as a plasma cutter, oxyacetylene torch or the like. Although these specific cutting apparatuses are mentioned, this disclosure is not meant to limit the types of cutting apparatuses.

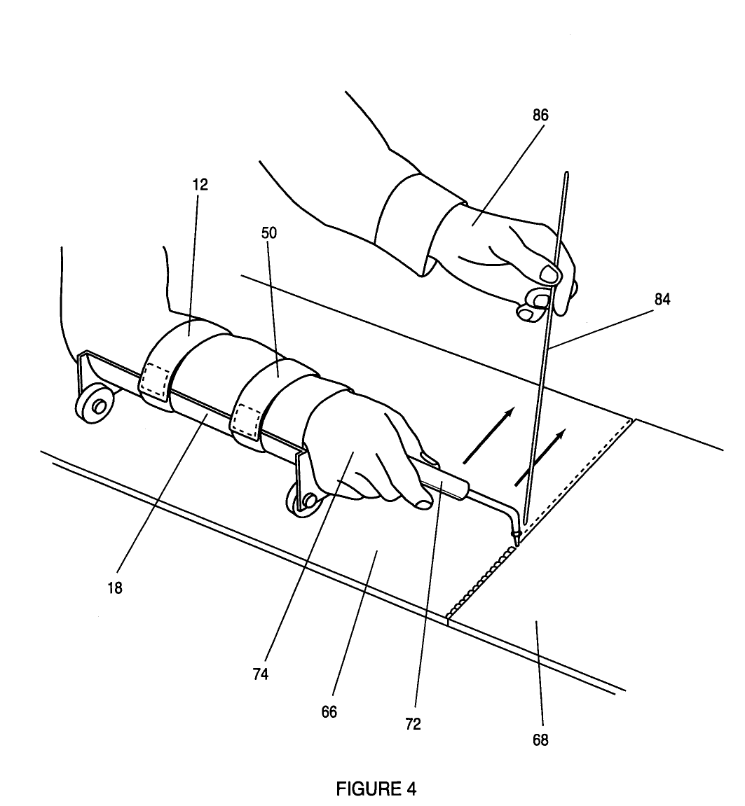

The metal cutting and welding guide can also be used in all welding operations. In that case, the operator would perform the same function as demonstrated in FIG. 3 except the operator would be welding two pieces of metal instead of cutting. FIG. 4 represents an operator using the invention as a guide for welding. Cradle 18 is wrapped around operator's arm and fastened using two hook and loop fasteners such as Velcro® straps 12 and 50. The operator places the rolling mechanism on metal piece 66 to be welded to metal piece 68. Operator holds welder 72 with first hand 74 which is encased in cradle 18 of the welding guide. Operator moves first hand 74 which in turn moves the welding guide along pre-determined path 70, welding along the path. Operator holds welding rod 84 in second hand 86 as he welds along the pre-determined path. Many different types of welding apparatuses can be used with the preferred metal cutting and welding guide, such as TIG welding, MIG welding, electric arc welding, oxyacetylene welding or the like. Although these specific welding apparatuses are mentioned, this disclosure is not meant to limit the types of welding apparatuses.

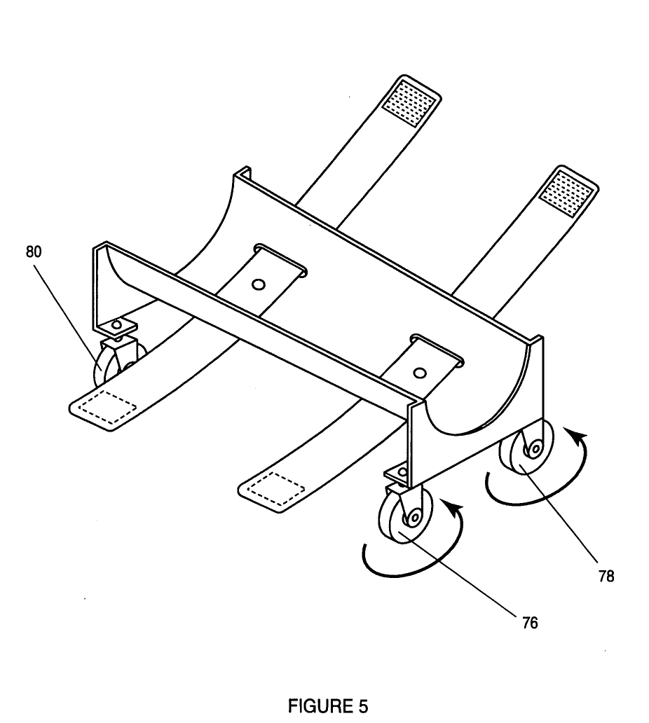

FIG. 5 represents the alternative swivel rolling mechanism, allowing operator to cut or weld curves, arcs or any other pattern. Using a pre-determined pattern, swivel wheels 76, 78, 80 and 82 can be used to cut or weld non-linear shapes. The metal cutting and welding guide is used in the same manner as described above except the rolling mechanism can move omni-directionally instead of linearly.

Although this description describes using the guide for cutting metal, the guide can also be used for cutting other materials such as fiberglass or plastic. The invention would be used in the same manner, but with a different kind of cutting tool (not shown).

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. An apparatus for a metal cutting and welding guide comprising:
a cradle;
at least one rolling member affixed to said cradle; and
a mechanism configured to attach said cradle to an arm

2. The invention of claim 1 wherein said cradle comprises of a heat resistant material.

3. The invention of claim 1 wherein said mechanism configured to attach said cradle to an arm is at least one strap.

4. The invention of claim 1 wherein said at least one rolling member comprises a linear rolling member.

5. The invention of claim 1 wherein the said at least one rolling member comprises a swiveling rolling member.

6. The invention of claim 1 wherein said cradle comprises a U shaped member.

7. The invention of claim 1 wherein said cradle comprises a circular sleeve.

8. A method for cutting a metal surface, the method comprising the steps of:
providing a cradle configured to be removeably affixed to an arm grasping a metal cutting apparatus;
rolling the cradle across a predetermined pattern on a surface of the metal; and
simultaneously cutting the metal in the predetermined pattern using the metal cutting apparatus.

9. The method of claim 8, wherein the step of rolling comprises rolling in a linear direction.

10. The method of claim 8, wherein the step of rolling comprises rolling in any pre-determined direction.

11. A method for welding at least two metal surfaces together, the method comprising the steps of:
providing a cradle configured to be removeably affixed to an arm grasping a welding apparatus;
rolling the cradle across a predetermined pattern on between the at least two metal surfaces to be welded; and
simultaneously welding the at least two metal surfaces in the predetermined pattern using the welding apparatus.

12. The method of claim 11, wherein the step of rolling comprises rolling in a linear direction.

13. The method of claim 8, wherein the step of rolling comprises rolling in any pre-determined direction.
